(19) United States
(12) Patent Application Publication
(10) Pub. No.: US 2007/0221341 A1
(43) Pub. Date: Sep. 27, 2007

(54) Wind Resistant Rolling Shutter with Anti-Galling Track

(76) Inventor: Joachim Schanz, Ocean View (DE)

Correspondence Address: DAVID KIEWIT, 5901 THIRD ST SOUTH, ST PETERSBURG, FL, 33705, US

(21) Appl. No.: 11/277,537

(22) Filed: Mar. 27, 2006

(51) Int. Cl. E06B 9/08

(52) U.S. Cl. 160/133; 160/235

(57) ABSTRACT

A track-guided flexible closure of the sort commonly referred to as a roll-down shutter has a plurality of longitudinally interconnected elongated slats extending between two parallel tracks. The closure may be connected to the tracks by metal retaining members slidable within the associated track. In an improved closure each track is a composite track made up of an external metal track member and a separate polymeric track liner within each metal track member. Each liner acts to prohibit contact between the respective metal track member and any of the retaining members over most of the total length of the track.

### BACKGROUND OF THE INVENTION

1. Field of the Invention

The invention relates to a track-guided flexible closure providing a barrier comprising a plurality of slats that are flexibly interconnected to each other along their length. Retaining members are provided at both ends of at least some of the slats to couple those slats to a parallel pair of tracks that are usually in a vertical orientation. More specifically, the present invention deals with roll-type closures that are strong enough to resist hurricane-force winds and that comprise a plurality of aluminum slats connected to a pair of aluminum tracks.

2. Background Information

Track-guided roll-type flexible closures are often made of a plurality of nominally rigid slats or panels interconnected along their longitudinal edges by hinge arrangements. Large closures of this sort, such as those used for overhead garage doors and the like, commonly have at least some of the slats or panels connected to the tracks by a wheel mounted on a stub axle attached to the slat or panel and captured for rolling motion within one of the tracks. Smaller closures of this type, such as those used for hurricane shutters, commonly have slats connected to tracks by means of retaining members, each of which has one end fixedly attached to a slat and the other end captured within a track for sliding motion along the track.

Roll-type closures made for use as protective shutters commonly comprise a plurality of extruded slats, which may have integrally formed bosses running the length of the slat so that a screw turned into the boss can serve as a retaining member. Roll-type hurricane shutters are generally made with metal slats, metal retaining members and metal tracks, although some plastic slats have been made that are strong enough for this purpose. Quasius, in U.S. Pat. No. 5,839,493, for example, shows a roll-type closure using a retaining member captured within a metal track for slidable motion therealong.

One problem with these all-metal configurations, which are generally not lubricated, is galling, that is the shutter can become stuck at what is supposed to be the sliding interface between the retainer and the track. Zabala, in U.S. Pat. No. 6,631,749 and Schlater et al., in U.S. Pat. No. 6,951,236 both provide means for avoiding metal-to-metal contact in a hurricane shutter by introducing plastic collars and the like for their retaining members. Although both of these teachings avoid metal-to-metal contact in the track portion of the shutter, both do so by adding additional parts and additional assembly steps to the process of making a hurricane shutter.

Kirkey et al. in U.S. Pat. No. 5,964,270 also teach an approach to reducing friction at a panel-to-track interface in a closure made from single flexible sheet of material, rather than from a plurality of slats.

### BRIEF SUMMARY OF THE INVENTION

The invention provides a track-guided flexible closure comprising a plurality of longitudinally interconnected elongated slats extending between two parallel tracks. This closure is connected to the tracks by metal retaining members slidable within the associated track. Each track is a composite track comprising an external metal track member and a polymeric track liner disposed within a respective metal track member and acting to prohibit contact between the respective metal track member and any of the retaining members over most of the total length of the track.

A preferred embodiment of the invention is a track-guided, flexible closure comprising metal or plastic slats, composite tracks and metal retaining members linking the slats to the tracks. The slats are elongated and hingedly interconnected at their longitudinal edges. Two parallel composite guide tracks each comprise an elongated polymeric liner member received within a respective metal track member. The metal retaining members each have a first end fixedly attached to one of the ends of one of the slats and have an enlarged head portion at the second end. The head portion is captured within the polymeric liner member of the track for slidable motion therealong.

Although it is believed that the foregoing rather broad summary description may be of use to one who is skilled in the art and who wishes to learn how to practice the invention, it will be recognized that the foregoing recital is not intended to list all of the features and advantages. Those skilled in the art will appreciate that they may readily use both the underlying ideas and the specific embodiments disclosed in the following Detailed Description as a basis for designing other arrangements for carrying out the same purposes of the present invention and that such equivalent constructions are within the spirit and scope of the invention in its broadest form. Moreover, it may be noted that different embodiments of the invention may provide various combinations of the recited features and advantages of the invention, and that less than all of the recited features and advantages may be provided by some embodiments.

### BRIEF DESCRIPTION OF THE SEVERAL VIEWS OF THE DRAWING

FIG. 1 is a partly cut away elevational detail view of a roll shutter.

FIG. 2 is an end elevational view of interconnected the slats comprising the shutter of FIG. 1.

FIG. 3 is a partial elevational view of a shutter assembly.

FIG. 4 is a partial cross-sectional view, taken as indicated by the arrows 4-4 in FIG. 1, of a composite track and shutter retaining member.

### DETAILED DESCRIPTION OF THE INVENTION

In studying this Detailed Description, the reader may be aided by noting definitions of certain words and phrases used throughout this patent document. Wherever those definitions are provided, those of ordinary skill in the art should understand that in many, if not most instances, such definitions apply to both preceding and following uses of such defined words and phrases. At the outset of this Description, one may note that the terms “include” and “comprise,” as well as derivatives thereof, mean inclusion without limitation; the term “or,” is inclusive, meaning and/or.

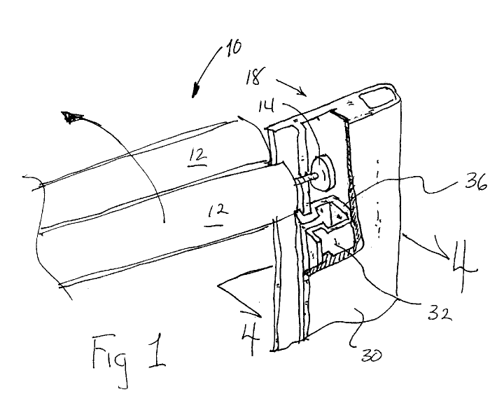

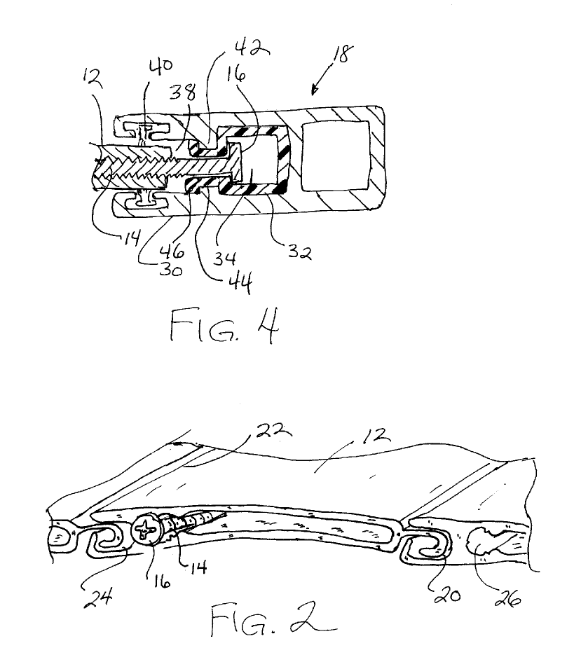

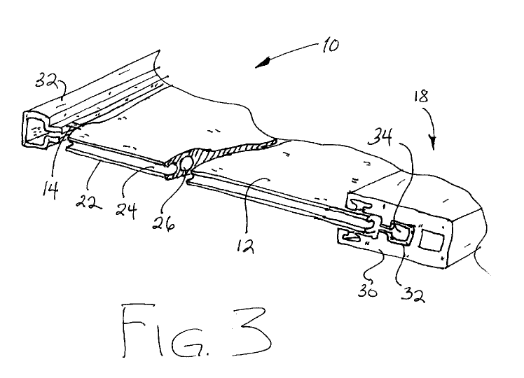

Turning now to FIG. 1, one finds a flexible closure 10 comprising a plurality of generally interconnected slats 12, at least some of which have retaining members 14 protruding longitudinally outwardly from their ends. The enlarged heads 16 of the retaining members 14 are captured in a track 18 so that the closure 10 can be moved along the track 18. Although a conventional hurricane shutter of this sort uses vertically oriented tracks 18, the reader will understand that other configurations are possible. For example, multi-slatted flexible closures used on furniture are often configured to move horizontally. Moreover, although hurricane shutters conventionally provide for storing the closure by rolling it about an axle (not shown) above the window or door being protected, the reader will understand that other storage approaches are known. These include, for example, the use of a horizontal storage track coupled to the vertical track by a curved section, as is commonly used in overhead garage doors.

With two exceptions, each of the slats 12 in the closure 10 is flexibly and hingedly connected along both of its two longitudinal edges 20, 22 to each of two neighboring slats. The exceptions to this are the slats at the end of the closure. One of these may be connected to the axle (not shown) by some convenient and known means and the other, at the free end of the closure, may terminate in a reinforced latching slat (not shown).

Although there are many approaches known in the art for interconnecting slats in a roll-type closure, in a preferred embodiment each slat 12 comprises a piece of an aluminum extrusion having a keyed or hooked trailing edge 20 and a slotted leading edge 22 having a hook-receiving boss 24 immediately behind the slot. Another, retainer-receiving boss 26 is disposed adjacent the key-receiving boss 24. Each retainer 14 is preferably a screw having an enlarged head and a shaft size selected to threadably engage the retainer-receiving boss 26. Those skilled in the art will recognize that there are many possible approaches for attaching a slat to a metal retaining member. These include, but are not limited to, adhesively bonding a threaded or unthreaded retaining member to a slat, or using a pop-rivet having an expanded portion received within the slat.

Although the depicted preferred embodiment has a single retaining member receiving boss formed in each slat, the reader will appreciate that additional bosses could be supplied as needed. Moreover, it will be understood that in some cases not all of the slats will have retaining members attached directly to them. For example, in some configurations every other slat in the closure has a respective retaining member screwed into each end of its integrally formed boss.

The invention employs a composite track structure to avoid direct contact between a retaining member 14 and a metal track surface over at least a portion of the track. This composite track 18 comprises an external metal track member 30 having a polymeric liner member 32 inserted into a guide channel 34. In a particular preferred embodiment, the metal track member 30 is an aluminum extrusion and the polymeric liner is a polyvinylchloride extrusion.

In a preferred embodiment, the metal track member comprises an entrance slot 38 that may contain brushes 40 or similar structures for excluding dust and dirt. The entrance slot 38 is separated from a guide channel 34 by a restricted throat region 42. The dimensions of a preferred liner 32 are selected so that the liner is snugly received within the guide channel 34. Moreover, a preferred liner 32 comprises a relatively narrow slot portion 44 intended to be received in the throat region of the metal track member, and an outwardly turned locking portion 46 intended to extend into the entrance slot portion 38 of the metal track member so as to aid in holding the liner in position in the guard channel.

In some embodiments of the invention, the plastic track liner 32 is slightly shorter than the metal track member 30 so as to provide a leaden region adjacent the top of the track. This arrangement avoids damage to the liner 32, which could occur if the liner extended beyond the end of the metal portion of the track. Moreover, in some embodiments a leaden end portion 36 of the liner 32 is thinned down so as to improve the leaden performance.

Although the present invention has been described with respect to several preferred embodiments, many modifications and alterations can be made without departing from the invention. Accordingly, it is intended that all such modifications and alterations be considered as within the spirit and scope of the invention as defined in the attached claims.

What is claimed is:

1) A track-guided, flexible closure comprising
a first plurality of elongated interconnected slats, each of the slats having two respective longitudinal connection edges and respective first and second opposing ends, each of the opposing ends adjacent a respective one of two composite guide tracks;
each of the composite guide tracks comprising a respective elongated polymeric liner member received within a respective elongated metal track member; and
a second plurality of metal linking members, each of the linking members having a first end fixedly attached to a respective one of the slats adjacent one of the ends thereof and a second end comprising an enlarged head portion captured within the respective adjacent polymeric liner member for slidable motion therealong.

2) The closure of claim 1 wherein each of the slats comprises an aluminum extrusion.

3) The closure of claim 1 wherein each of the polymeric liners is shorter than the respective metal track member whereby each of the composite guide tracks comprises a respective end portion having no portion of the respective liner captured therein.

4) The closure of claim 1 wherein each polymeric liner member comprises a respective extruded polyvinylchloride member.

5) The closure of claim 1 wherein each metal linking member comprises a screw threadably received within a boss portion of a respective one of the slats.

6) In a track-guided flexible closure comprising a plurality of longitudinally interconnected elongated slats extending between two parallel tracks, the slats connected to the tracks for slidable motion therealong by a second plurality of metal retaining members, an improvement characterized by each track comprising a respective external metal track member and a respective polymeric track liner disposed within the respective metal track member and acting to prohibit contact between at least a portion of the respective metal track member and any of the retaining members.

7) The closure of claim 6 wherein each of the slats comprises a respective extruded metal member having an internal screw-receiving boss integrally formed therewith and wherein each of the metal retaining members comprises a respective screw turned into a respective one of the bosses.

8) The closure of claim 6 wherein each of the slats and each of the external metal members are formed from an aluminum alloy.

9) The closure of claim 6 wherein the polymeric liner is formed from a polyvinylchloride polymer.

10) The closure of claim 6 wherein the parallel tracks are disposed vertically and wherein each of the tracks comprises a respective lead-in portion adjacent a respective upper end thereof, each lead-in portion having no liner portion disposed therewithin.
